(19) United States
(12) Patent Application Publication
(10) Pub. No.: US 2024/0099419 A1
(43) Pub. Date: Mar. 28, 2024

(54) SYSTEM AND METHOD FOR CALIBRATING FORCE SENSORS

(71) Applicant: Orpyx Medical Technologies Inc., Calgary (CA)

(72) Inventors: SANJAY GUPTA, BEDFORD, MA (US); SAMUEL CARL WILLIAM BLADES, VICTORIA (CA)

(21) Appl. No.: 18/465,511

(22) Filed: Sep. 12, 2023

Related U.S. Application Data
(60) Provisional application No. 63/408,917, filed on Sep. 22, 2022.

(51) Int. Cl. A43B 3/44; A43B 3/40; H02J 50/90

(52) U.S. Cl. CPC A43B 3/44; A43B 3/40; H02J 50/90

(57) ABSTRACT

A system, method, and computer program product for calibrating force sensors is provided. The force sensors can be provided in a wearable device worn by a user underfoot. A force sensing apparatus has a plurality of apparatus force sensors and a charging unit. The charging unit can charge an energy storage device of the wearable device when the wearable device is received on the upper surface of the apparatus. The force sensing apparatus can sense a force applied to the upper surface of the apparatus when the wearable device is worn by a user while standing on the upper surface of the apparatus. At the same time, the force sensors in the wearable device can generate sensor readings. The system can determine a calibration model for the device force sensors by comparing the force values from the apparatus force sensors and the device force sensors in the wearable device.

### CROSS-REFERENCE TO RELATED APPLICATIONS

This application claims the benefit of priority of U.S. Provisional Application No. 63/408,917 filed Sep. 22, 2022, which is incorporated herein by reference.

### FIELD

This document relates to systems and methods for processing data from sensors monitoring human movement or human activity. In particular, this document relates to calibrating force sensors that are positioned underfoot.

### BACKGROUND

U.S. Pat. No. 11,159,065 (Bossetti et al.) discloses a wireless charging mat and method of operating the same. The wireless charging mat includes a detection system configured to determine a location and an orientation of an electronic device on the wireless charging mat. The location and orientation are determined based on detected locations of one or more structural features of the electronic device. The wireless charging mat is operated according to the detected location and orientation.

United States Patent Application Publication No. 2018/0231393 (Czaja et al.) discloses a method of correcting inaccuracies in measurement of force, acceleration and orientation vectors introduced during fabrication of motion and ground reaction forces analysis system embedded in footwear insoles.

### SUMMARY

The following summary is intended to introduce the reader to various aspects of the detailed description, but not to define or delimit any invention.

A system, method, and computer program product for calibrating force sensors is provided. The force sensors can be provided in a wearable device worn by a user underfoot. The system can include a force sensing apparatus that has a plurality of apparatus force sensors and a charging unit. The force sensing apparatus can sense a force applied to the upper surface of the apparatus. The charging unit can charge an energy storage device of the wearable device when the wearable device is received on the upper surface of the apparatus.

A force can be measured by the apparatus force sensors when the wearable device is worn by a user while standing on the upper surface of the apparatus. At the same time, the force sensors in the wearable device can generate sensor readings. The system can determine a calibration model for the device force sensors by comparing the force values from the apparatus force sensors and the device force sensors in the wearable device. The calibration model can be used to adjust the force values from the device force sensors.

According to some aspects, the present disclosure provides a system for calibrating a plurality of force sensors in a wearable device worn by a user, wherein the plurality of force sensors are positioned underfoot. The system can include a force sensing apparatus comprising an upper surface and a plurality of apparatus force sensors, wherein the upper surface is configured to receive the wearable device while the wearable device is worn by the user, the plurality of apparatus force sensors are arranged below the upper surface, and the plurality of apparatus force sensors are configured to sense a force applied to the upper surface; a charging unit operable to charge an energy storage device of the wearable device when the wearable device is received on the upper surface; one or more processors in communication with the wearable device; and a non-transitory storage memory; wherein the one or more processors are configured to determine a first measured force value, wherein the first measured force value is determined based on a first plurality of measured sensor readings from the plurality of force sensors while the wearable device is worn by the user while standing on the upper surface; determine a second measured force value, wherein the second measured force value is determined based on a second plurality of measured sensor readings from the plurality of apparatus force sensors while the wearable device is worn by the user while standing on the upper surface; and determine a calibration model for the plurality of force sensors by comparing the first measured force value and the second measured force value.

The force sensing apparatus can include an apparatus inertial measurement unit (IMU) and the one or more processors can be configured to: obtain concurrent first IMU angle measurement and second IMU angle measurement, where the first IMU angle measurement is obtained from a wearable device IMU provided by the wearable device while the wearable device is worn by the user while standing on the upper surface and the second IMU angle measurement is obtained from the apparatus IMU; determine a device IMU angle for the wearable device IMU by comparing the first IMU angle measurement and the second IMU angle measurement; and output the device IMU angle.

The one or more processors can be configured to output the device IMU angle by storing the device IMU angle in the non-transitory storage memory.

The one or more processors can be further configured to output the calibration model.

The one or more processors can be configured to output the calibration model by storing the calibration model in the non-transitory storage memory.

The non-transitory storage memory can be contained within the wearable device.

The wearable device can be footwear.

The footwear can be an insole.

The force sensing apparatus can be portable.

The force sensing apparatus can be foldable.

The force sensing apparatus can include a receptacle within which the wearable device is receivable when the wearable device is not being worn by the user.

The charging unit can operate to charge the energy storage device and the plurality of apparatus force sensors can operate concurrently to sense the force applied to the upper surface when the wearable device is received on the upper surface.

The charging unit can be a wireless charging unit.

The charging unit can operate to charge the wearable device over a defined portion of the upper surface and the upper surface can include an alignment guide indicating the defined portion of the upper surface upon which the wearable device is receivable to undergo charging by the charging unit.

The force sensing apparatus can include a visual indicator operable to indicate that the wearable device is undergoing charging by the charging unit.

The system can include a housing containing the plurality of apparatus force sensors and the charging unit, the housing defining the upper surface.

The charging unit can be positioned between the plurality of apparatus force sensors and the upper surface.

The force sensing apparatus can include an electronics module associated with the plurality of apparatus force sensors, the charging unit can include a transmitter coil, and the housing can include shielding arranged to shield the transmitter coil from the electronics module.

The plurality of apparatus force sensors can be configured to sense the force applied to the upper surface with greater accuracy than the plurality of force sensors.

According to some aspects, the present disclosure provides a method of calibrating a plurality of force sensors in a wearable device worn by a user, wherein the plurality of force sensors are positioned underfoot. The method includes: determining a first measured force value, wherein the first measured force value is determined based on a first plurality of measured sensor readings from the plurality of force sensors while the wearable device is worn by the user while standing on an upper surface of a force sensing apparatus, wherein the force sensing apparatus comprises a plurality of apparatus force sensors arranged below the upper surface and the plurality of apparatus force sensors are configured to sense a force applied to the upper surface; determining a second measured force value, wherein the second measured force value is determined based on a second plurality of measured sensor readings from a plurality of apparatus force sensors while the wearable device is worn by the user while standing on the upper surface; and determining a calibration model for the plurality of force sensors by comparing the first measured force value and the second measured force value.

The force sensing apparatus can include an apparatus inertial measurement unit (IMU) and the one or more processors can be configured to: obtain a first IMU angle measurement from a wearable device IMU provided by the wearable device while the wearable device is worn by the user while standing on the upper surface; obtain a second IMU angle measurement from an apparatus IMU of the force sensing apparatus, where the first IMU angle measurement and the second IMU angle measurement are concurrent; determine a device IMU angle for the wearable device IMU by comparing the first IMU angle measurement and the second IMU angle measurement; and output the device IMU angle.

Outputting the device IMU angle can include storing the device IMU angle in the non-transitory storage memory.

The method can include outputting the calibration model.

Outputting the calibration model can include storing the calibration model in the non-transitory storage memory.

The non-transitory storage memory can be contained within the wearable device.

The wearable device can be footwear.

The footwear can be an insole.

The force sensing apparatus can be portable.

The force sensing apparatus can be foldable.

The method can include charging an energy storage device of the wearable device when the wearable device is received on the upper surface.

The energy storage device can be charged concurrently while the first plurality of measured sensor readings are obtained.

The energy storage device can be charged at a time other than when the first plurality of measured sensor readings are obtained.

The energy storage device can be charged wirelessly.

The method can include aligning the wearable device with a defined portion of the upper surface using an alignment guide. The defined portion can be a region of the upper surface upon which the wearable device is receivable to undergo charging by the charging unit.

The method can include outputting a visual indicator while the wearable device is undergoing charging by the charging unit.

The plurality of apparatus force sensors can be configured to sense the force applied to the upper surface with greater accuracy than the plurality of force sensors

According to some aspects, the present disclosure provides a non-transitory computer readable medium storing computer-executable instructions, which, when executed by a computer processor, cause the computer processor to carry out a method of calibrating a plurality of force sensors in a wearable device worn by a user, wherein the plurality of force sensors are positioned underfoot. The method includes: determining a first measured force value, wherein the first measured force value is determined based on a first plurality of measured sensor readings from the plurality of force sensors while the wearable device is worn by the user while standing on an upper surface of a force sensing apparatus, wherein the force sensing apparatus comprises a plurality of apparatus force sensors arranged below the upper surface and the plurality of apparatus force sensors are configured to sense a force applied to the upper surface; determining a second measured force value, wherein the second measured force value is determined based on a second plurality of measured sensor readings from a plurality of apparatus force sensors while the wearable device is worn by the user while standing on the upper surface; and determining a calibration model for the plurality of force sensors by comparing the first measured force value and the second measured force value.

The non-transitory computer readable medium can store computer-executable instructions, which, when executed by a computer processor, cause the computer processor to carry out the method of calibrating a plurality of force sensors in a wearable device worn by a user, where the method is described herein.

A system, method, and computer program product for calibrating force sensors in a wearable device while the wearable device is in use is also provided.

According to some aspects, the present disclosure provides a method of calibrating a plurality of force sensors in a wearable device worn by a user, wherein the plurality of force sensors are positioned underfoot. The method includes: obtaining a plurality of measured sensor readings from the plurality of force sensors while the wearable device is worn by the user while performing a particular action; determining at least one force measurement value corresponding to the particular action based on the plurality of measured sensor readings; and determining a calibration model by comparing the at least one force measurement value to at least one expected force value, wherein the calibration model is determined to minimize a difference between the at least one force measurement value and the at least one expected force value.

The method can include outputting the calibration model.

The at least one force measurement value can be an aggregate force value determined from the plurality of measured sensor readings; the at least one expected force value can be a known bodyweight of the user; and the calibration model can include a plurality of sensor calibration coefficients corresponding to the plurality of force sensors.

The at least one force measurement value can be a single sensor force value determined using measured sensor readings from a single force sensor in the plurality of force sensors; the at least one expected force value can include a plurality of neighboring sensor force values, each neighboring sensor force value determined using measured sensor readings from a neighboring force sensor that neighbors the single force sensor in the plurality of force sensors; and the calibration model can include a single sensor calibration coefficient corresponding to the single force sensor.

According to some aspects, the present disclosure provides a system for calibrating a plurality of force sensors in a wearable device worn by a user. The system includes: the plurality of sensors arranged in a first predetermined pattern, with each of the plurality of sensors arranged at respective locations on a carrier device, wherein the plurality of force sensors are positionable underfoot; and one or more processors communicatively coupled to the plurality of sensors, the one or more processors configured to: obtain a plurality of measured sensor readings from the plurality of force sensors while the wearable device is worn by the user while performing a particular action; determine at least one force measurement value corresponding to the particular action based on the plurality of measured sensor readings; and determine a calibration model by comparing the at least one force measurement value to at least one expected force value, wherein the calibration model is determined to minimize a difference between the at least one force measurement value and the at least one expected force value.

The one or more processors can be further configured to output the calibration model.

The at least one expected force value can be a known bodyweight of the user; and the one or more processors can be configured to: determine the at least one force measurement value as an aggregate force value from the plurality of measured sensor readings; and determine the calibration model to include a plurality of sensor calibration coefficients corresponding to the plurality of force sensors.

The at least one expected force value can include a plurality of neighboring sensor force values, each neighboring sensor force value determined using measured sensor readings from a neighboring force sensor that neighbors the single force sensor in the plurality of force sensors; and the one or more processors can be configured to: determine the at least one force measurement value as a single sensor force value using measured sensor readings from a single force sensor in the plurality of force sensors; and determine the calibration model to include a single sensor calibration coefficient corresponding to the single force sensor.

According to some aspects, the present disclosure provides a non-transitory computer readable medium storing computer-executable instructions, which, when executed by a computer processor, cause the computer processor to carry out a method of calibrating a plurality of force sensors in a wearable device worn by a user, wherein the plurality of force sensors are positioned underfoot. The method includes: obtaining a plurality of measured sensor readings from the plurality of force sensors while the wearable device is worn by the user while performing a particular action; determining at least one force measurement value corresponding to the particular action based on the plurality of measured sensor readings; and determining a calibration model by comparing the at least one force measurement value to at least one expected force value, wherein the calibration model is determined to minimize a difference between the at least one force measurement value and the at least one expected force value.

The non-transitory computer readable medium can store computer-executable instructions, which, when executed by a computer processor, cause the computer processor to carry out the method of calibrating a plurality of force sensors in a wearable device worn by a user, where the method is described herein.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example of a sensor calibration system;

FIG. 2 is a top view of an example sensor calibration system that can be used in the system of FIG. 1;

FIG. 3 is a bottom view of an example foldable sensor calibration system that can be used in the system of FIG. 1;

FIG. 4 is a diagram illustrating an example of a wearable device incorporating a sensing unit that can be calibrated using the system of FIG. 1;

FIG. 5 is a flowchart illustrating an example of a method for determining a calibration model using a calibration system such as the example system such in FIG. 1;

FIG. 6 is a flowchart illustrating an example of a method for determining a calibration model for a wearable device during use of the wearable device;

FIG. 7A is a plot of force values corresponding to sensor readings from a plurality of underfoot force sensors during a gait cycle prior to drift correction;

FIG. 7B is a plot of the force values shown in FIG. 7A after drift correction;

FIG. 8A is a plot of force values corresponding to sensor readings from a plurality of underfoot force sensors during a cyclic activity prior to drift correction; and

FIG. 8B is a plot of the force values shown in FIG. 8A after drift correction.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details.

In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context.

Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof. Furthermore, the wording “at least one of A and B” is intended to mean only A (i.e. one or multiple of A), only B (i.e. one or multiple of B), or a combination of one or more of A and one or more of B.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g. 112a, or 1121). Multiple elements herein may be identified by part numbers that share a base number in common and that differ by their suffixes (e.g. 1121, 1122, and 1123). All elements with a common base number may be referred to collectively or generically using the base number without a suffix (e.g. 112).

Described herein are systems, methods and devices for calibrating force sensor data from a plurality of force sensors positioned underfoot. The systems, methods and devices described herein can provide a combined system that can both charge and calibrate force sensing units worn underfoot. The systems, methods, and devices can in some examples use sensors attached to, or contained within, wearable devices to measure and monitor data relating to movement or activity of an individual. The measured data from the sensors can be used to calculate various force-related metrics.

The sensors can be force sensors and can be provided in the insole of a shoe or within the footwear worn by the individual. As used herein, the term “force” is used broadly and can refer to raw force (i.e. with units of N), or pressure resulting from a raw force (i.e. with units of N/m2). The force data acquired by the force sensors can be used to determine the level of force applied by an individual's foot when performing various activities such as walking, running, or jumping for example. This force data can be used to derive additional force derivatives or force-based metrics, such as the force output or the center of pressure for the individual. The force data, and other data derived therefrom, can be used for tracking and monitoring various parameters that may be useful for medical, fitness, athletic, entertainment or other purposes.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C, for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer-useable instructions may also be in various formats, including compiled and non-compiled code.

Sensors require calibration to maintain measurement accuracy and reproducibility. Sensors are prone to signal drift, and without calibration, sensor readings may become inaccurate. Sensor responses may also change in response to changes in external conditions. The present disclosure relates to systems, methods and devices that can be used to calibrate force sensors worn underfoot.

A sensorized device (i.e. a device incorporating sensors) can undergo an initial factory calibration when being manufactured. Factory calibration can ensure that a sensorized device is accurate from the outset. However, calibration can be a time-consuming and costly step to perform during manufacturing. Furthermore, sensors may become uncalibrated over time, e.g. due to drift or changes in sensor response due to different external conditions. Accordingly, it may be desirable to continue calibrating the sensorized device after manufacturing and even while in the possession of the ultimate end-user.

The present disclosure relates to systems, methods and devices that can be used to provide force sensor calibration for a sensorized device after manufacturing (e.g. when in possession of a user). The present disclosure provides various examples of calibration systems, methods and devices that allow for “inter-use” calibration and/or “intra-use” calibration.

As used herein, “inter-use calibration” refers to calibrations that occur between uses of the sensorized device (i.e. once a user is in possession of the device but in between periods when the user is using the device). Inter-use calibration can involve a force sensing apparatus with force sensors capable of sensing an applied force with greater accuracy than the sensors contained in the sensorized device. Inter-use calibration can help maintain the accuracy of the sensorized device over time. For example, the force sensing apparatus can be used to correct drift in the sensorized device.

Inter-use calibration can involve active participation on the part of the user. For example, a user may be required to perform a calibration routine (e.g. a user may be instructed to walk 10 steps, stand on a scale, etc.). However, users often find it cumbersome or inconvenient to perform a calibration routine. As a result, users often do not calibrate their sensorized devices as frequently as required, leading to inaccurate sensor measurements. Accordingly, the systems, methods and devices described herein can provide a simple and convenient process for inter-use calibration that can promote more frequent calibration on the part of the end-user.

As used herein, “intra-use calibration” refers to calibrations that occur while the sensorized device is in use (and typically occurs unbeknownst to users). Intra-use calibration occurs at points in time when the sensed variable (e.g. force) is known. A known reference value of the force is compared to the measured value. If there is a difference, the sensors can be calibrated until the two values match.

Intra-use calibration does not require any effort from the user. However, intra-use calibration requires the reference value to be updated in response to any changes. For example, if a user's body weight is initially recorded while wearing lightweight clothing, that initial body weight value may be incorrect when the user wears heavier clothing. This can result in inaccurate calibrations of force sensors.

Intra-use calibration may also not be adept at identifying all types of errors. For example it may be difficult to detect drift without an external reference device. As a result, intra-use calibration often still requires supplemental calibration (e.g. inter-use calibration) to ensure sensor accuracy.

As described herein, a system for calibrating force sensors may provide a number of advantages for inter-use calibration. The calibration system may minimize or eliminate the need for factory calibration, thereby reducing manufacturing costs. In addition, the calibration system can include a force sensing apparatus that is convenient for users, which may promote more frequent calibrations. For example, the force sensing apparatus may be multi-purpose and both calibrate and charge the sensorized device. This may encourage users to perform an inter-use calibration routine regularly as part of the process of charging the sensorized device (which they would be required to do in any event).

The force sensing apparatus may be provided in the form of a mat. The mat can contain a plurality of force sensors and a charging unit. Calibrating the sensorized device (e.g. sensorized footwear) using the force sensing mat may require users to stand on the mat for a brief period of time. This process can be convenient for users as they can calibrate the sensorized device while the device is charging (or while the device is positioned for charging), a task which is to be completed regardless. For example, the mat may include a wireless charging unit allowing a user to easily position the device for charging while also performing a calibration routine. The mat may be used in environments such as a user's home, where it can remain, for example, on a floor near where the user typically removes their shoes, or in the same room as a game console.

A wireless charging unit may in some examples be relatively easy to use, particularly for users of limited dexterity and/or mobility. For example, the wireless charging unit may be used without necessarily requiring that the sensorized insole(s) be removed from the user's shoe(s), and without necessarily requiring a plug or receptacle of the wireless charging unit to be mated to a corresponding plug or receptacle of the sensorized insole. That is, the user may simply place the shoe on a wireless charging mat. The wireless charging mat may then commence charging the sensorized insole via an LC (inductor capacitor) circuit.

The systems and methods described herein can also enable intra-use calibration of force sensors worn underfoot. This can further ensure that the force sensors remain accurate while the device is in use.

The inter-use and intra-use calibration systems and methods described herein can be combined to further ensure that high sensor accuracy can be maintained by the pressure-sensing insoles. For example, the force sensing apparatus may capture the reference bodyweight value each time an inter-use calibration is performed. Accordingly, the reference bodyweight value required for intra-use calibrations can be updated frequently to account for any changes (e.g. due to changes in clothing, weight loss/gain, daily weight changes, etc.). This can further ensure that the intra-use calibrations remain accurate for the user.

The systems, methods and devices described herein can also include one or more inertial measurement units (IMUs) in the force sensing apparatus. A sensorized device can include an IMU in addition to the force sensors. The calibration systems, methods and devices described herein may also be configured to calibrate the orientation of the device IMU, in some cases concurrently with calibrating the force sensors, using the IMU in the force sensing apparatus.

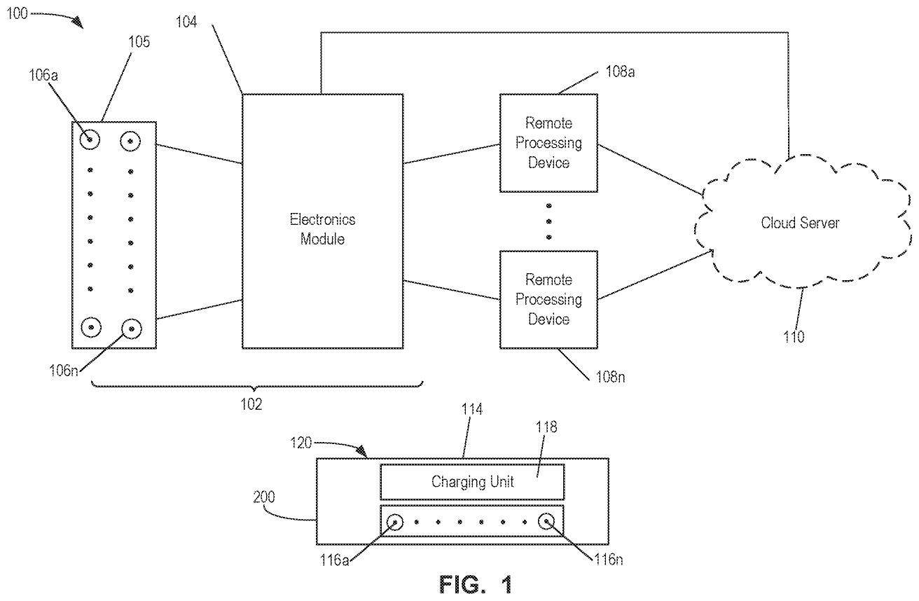

Referring now to FIG. 1, shown therein is a block diagram illustrating an example system 100 that can be used to calibrate force sensors. System 100 includes a plurality of sensors positionable underfoot of an individual performing an activity or other type of movement. The sensors may be provided using a wearable device that can be worn by a user underfoot.

System 100 includes an input unit 102 (also referred to herein as an input device), one or more processing devices 108 (also referred to herein as a receiving device or an output device) and an optional remote cloud server 110. As will be described in further detail below, the input unit 102 may for example be combined with, or integrated into, a wearable device. System 100 also includes a force sensing apparatus 114.

Input unit 102 generally includes a sensing unit 105. The force sensing apparatus 114 can be used to calibrate the sensors provided by sensing unit 105.

The sensing unit 105 can include a plurality of sensors 106a-106n. The plurality of sensors 106a-106n can be configured to collect force sensor data from underneath an individual's foot.

Optionally, input unit 102 can include an inertial measurement unit (IMU). The IMU can include one or more sensors for measuring the position and/or motion of the individual's foot (e.g. via a carrier unit). For example, the IMU may include sensors such as one or more of a gyroscope, accelerometer (e.g., a three-axis accelerometer), magnetometer, orientation sensor (for measuring orientation and/or changes in orientation), angular velocity sensor, and inclination sensor.

The IMU can also be positioned underneath an individual's foot. However, the IMU need not be positioned underfoot so long as the IMU can collect inertial measurement data relating to the position and/or motion of the foot.

The carrier unit can be configured to position the sensors 106 in contact with (or in close proximity to) an individual's body to allow the sensors 106 to measure an aspect of the activity being performed by the individual. The plurality of sensors 106a-106n may be configured to measure a particular sensed variable at a location of an individual's body when the carrier unit is engaged with the individual's body (e.g. when the individual is wearing a wearable device containing the sensors 106 or when the individual is using fitness equipment containing the sensors 106). In system 100, the plurality of sensors 106a-106n can be arranged to measure force underneath the foot (underfoot) of an individual.

In some examples, the carrier unit may include one or more wearable devices. The wearable devices can be manufactured of various materials such as fabric, cloth, polymer, or foam materials suitable for being worn close to, or in contact with, a user's skin. All or a portion of the wearable device may be made of breathable materials to increase comfort while a user is performing an activity.

In some examples, the wearable device may be formed into a garment or form of apparel such as a sock, a shoe, or an insole. Some wearable devices such as socks may be in direct contact with a user's skin. Some wearable devices, such as shoes, may not be in direct contact with a user's skin but still positioned within sufficient proximity to a user's body to allow the sensors to acquire the desired readings.

In some cases, the wearable device may be a compression-fit garment. The compression-fit garment may be manufactured from a material that is compressive. A compression-fit garment may minimize the impact from “motion artifacts” by reducing the relative movement of the wearable device with respect to a target location on the individual's body. In some cases, the wearable device may also include anti-slip components on the skin-facing surface. For example, a silicone grip may be provided on the skin-facing surface of the wearable device to further reduce the potential for motion artifacts.

The wearable device can be worn on a foot. For example, the wearable device may be a shoe, a sock, or an insole, or a portion of a shoe, a sock, or an insole. The wearable device may include a deformable material, such as foam. This may be particularly useful where the wearable device is a shoe or insole.

The plurality of sensors 106a-106n can be positioned to acquire sensor reading from specified locations on an individual's body (via the arrangement of the sensors on the carrier unit). The sensors 106 can be integrated into the material of the carrier unit (e.g. integrated into a wearable device). Alternatively, the sensors 106 can be affixed or attached to the carrier unit, e.g. printed, glued, laminated or ironed onto a surface, or between layers, of a wearable device.

In some examples, the sensors 106 and IMU may be provided by the same carrier unit. Alternatively, the IMU may be provided by a separate carrier unit.

For clarity, the below description relates to a carrier unit in the form of an insole. The insole carrier unit may be provided in various forms, such as an insert for footwear, or integrated into a shoe. However, other carrier units may be implemented using the systems and methods described herein, such as the example wearable devices described above. Incorporating the sensing unit 105 (and optionally the IMU) into a wearable device may be desirable as it allows force sensor data to be analyzed for an individual performing activities at various locations and without requiring specifically configured fitness equipment.

The below description relates to an insole in which the plurality of sensors 106 are force sensors. Various types of force sensors may be used, such as force sensing resistors (also referred to as “sensels” or sensing elements), pressure sensors, piezoelectric tactile sensors, elasto-resistive sensors, capacitive sensors or more generally any type of force sensor that can be integrated into a wearable device.

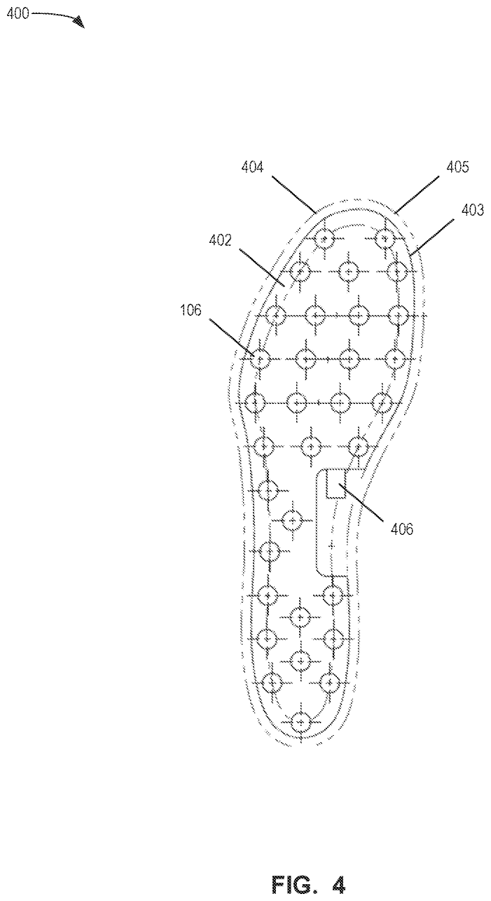

The plurality of sensors 106 may be arranged into a sensor array. As used herein, the term sensor array refers to a series of sensors arranged in a defined grid. The plurality of sensors 106 can be arranged in various types of sensor arrays. For example, the plurality of sensors 106 can be provided as a set of discrete sensors (see e.g. FIG. 4). A discrete sensor is an individual sensor that acquires a sensor reading at a single location. A set of discrete sensors generally refers to multiple discrete sensors that are arranged in a spaced apart relationship in a sensing unit.

Sensors 106a-106n may be arranged in a sparse array of discrete sensors that includes void locations where no sensors 106 are located. Alternatively, sensors 106a-106n may be arranged in a continuous or dense sensor array in which sensors 106 are arranged in a continuous, or substantially continuous manner, across the grid.

Discrete sensors can provide an inexpensive alternative to dense sensor arrays for many applications. However, because no sensors are positioned in the interstitial locations between the discrete sensors and the void locations external to the set of discrete sensors, no actual sensor readings can be acquired for these locations. Accordingly, depending on the desired resolution for the force sensor data, sensor readings may be estimated (rather than measured) at the interstitial locations and at the void locations external to the set of discrete sensors in order to provide sensor data with similar resolution to a dense sensor array. Alternatively, where lower resolution force sensor data is sufficient, sensor readings may not necessarily be estimated.

Various interpolation and extrapolation techniques may be used to estimate sensor values at interstitial locations and external void locations. In some cases, sensor values may be estimated using the methods for synthesizing sensor data described in Applicant's co-pending patent application Ser. No. 17/988,468 filed on Nov. 16, 2022 entitled “SYSTEM AND METHOD FOR SYNTHESIZING SENSOR READINGS”, the entirety of which is incorporated herein by reference. In some cases, sensor values may be estimated using the methods for synthesizing sensor data described in Applicant's co-pending patent application Ser. No. 18/183,642 filed on Mar. 14, 2023 entitled “SYSTEM AND METHOD FOR DETERMINING USER-SPECIFIC ESTIMATION WEIGHTS FOR SYNTHESIZING SENSOR READINGS”, the entirety of which is incorporated herein by reference.

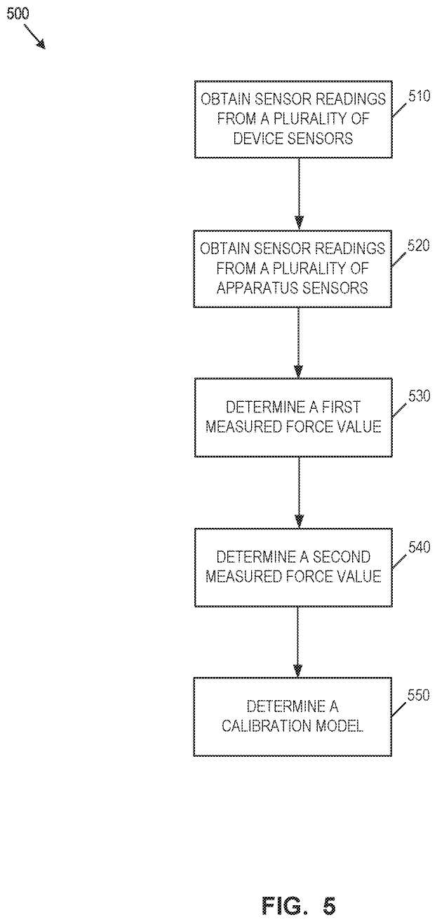

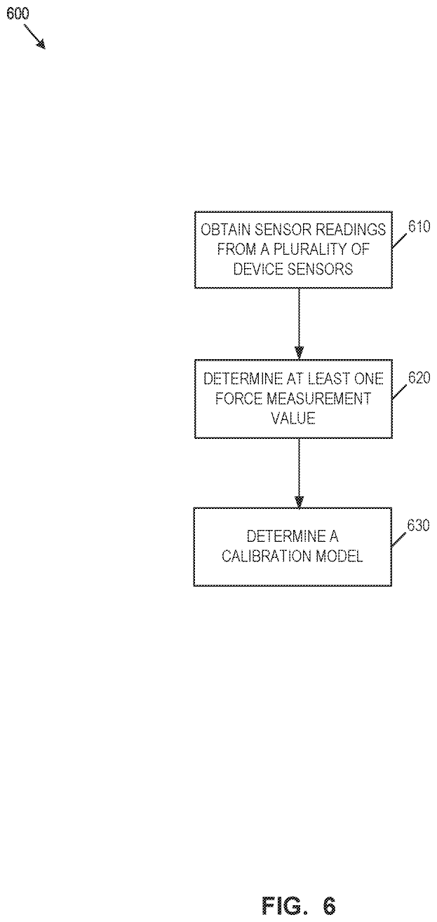

System 100 can be configured to implement various methods of processing force sensor data and calibrating force sensors. The methods of processing force sensor data may be implemented using a controller of the input device 102, a remote processing device 108, or cloud server 110. Examples of methods of processing force sensor data that may be implemented using system 100 include methods 500 and 600 shown in FIGS. 5 and 6 respectively and described in further detail herein below.

As shown in FIG. 1, input unit 102 includes an electronics module 104 coupled to the plurality of sensors 106 and to the optional IMU. In some cases, the electronics module 104 can include a power supply, a controller or other processing unit, a memory, a signal acquisition unit operatively coupled to the controller and to the plurality of sensors 106 (and to the IMU), and a wireless communication module operatively coupled to the controller.

The input unit 102 may include an onboard energy storage device that includes one or more energy storage members (e.g. one or more batteries or capacitors). The energy storage member(s) can be used to power the electronical and electronic components of the input unit 102.

Generally, the sensing unit refers to the plurality of sensors 106 and the signal acquisition unit. The signal acquisition unit may provide initial analog processing of signals acquired using the sensors 106, such as amplification. The signal acquisition unit may also include an analog-to-digital converter to convert the acquired signals from the continuous time domain to a discrete time domain. The analog-to-digital converter may then provide the digitized data to the controller for further analysis or for communication to a remote processing device 108 or remote cloud server 110 for further analysis.

Optionally, the electronics module 104 may include a controller or other processing device configured to perform the signal processing and analysis. In such cases, the controller on the electronics module 104 may be configured to process the received sensor readings in order to analyze the force sensor data. In some cases, the controller may be coupled to the communication module (and thereby the sensing unit) using a wired connection such as Universal Serial Bus (USB) or other port.

The electronics module 104 can be communicatively coupled to one or more remote processing devices 108a-108n, e.g. using a wireless communication module (e.g., Bluetooth, Bluetooth Low-Energy, Wi-Fi, ANT+ IEEE 802.11, etc.). The remote processing devices 108 can be any type of processing device such as (but not limited to) a personal computer, a tablet, and a mobile device such as a smartphone, a smartwatch or a wristband. The electronics modules 104 can also be communicatively coupled to remote cloud server 110 over, for example, a wide area network such as the Internet.

Each remote processing device 108 and optional remote cloud server 110 typically includes a processing unit, an output device (such as a display, speaker, and/or tactile feedback device), a user interface, an interface unit for communicating with other devices, Input/Output (1/O) hardware, a wireless unit (e.g. a radio that communicates using CDMA, GSM, GPRS or Bluetooth protocol according to standards such as IEEE 802.11a, 802.11b, 802.11g, or 802.11n), a power unit, and a memory unit. The memory unit can include RAM, ROM, one or more hard drives, one or more flash drives, or some other suitable data storage elements such as disk drives, etc.

The processing unit controls the operation of the remote processing device 108 or the remote cloud server 110 and can be any suitable processor, controller or digital signal processor that can provide sufficient processing power depending on the desired configuration, purposes, and requirements of the system 100.

Optionally, the remote processing device 108 may be included as part of the force sensing apparatus 114. That is, in some examples the functions described herein in relation to the remote processing device 108 and/or cloud server 110 may be implemented by a processor included in the force sensing apparatus. Alternatively, the remote processing device 108 and cloud server 110 can be separate from the force sensing apparatus 114.

The display can be any suitable display that provides visual information. For instance, the display can be a cathode ray tube, or a flat-screen monitor and the like if the remote processing device 108 or remote cloud server 110 is a desktop computer. In other cases, the display can be a display suitable for a laptop, tablet, or handheld device, such as an LED or LCD-based display and the like.

System 100 can generally be used to acquire and analyze force sensor data from sensors 106 and sensors 116 in order to perform various calibration operations for the sensors 106. In some cases, system 100 may also track IMU measurements and/or additional data derived from the sensor readings. The sensor readings, IMU measurements, calibration data, and derived data may be monitored, stored, and analyzed for the user. Aspects of the monitoring, storage and analysis of sensor readings, IMU measurements and calibration data may be performed by one or more of the input unit 102, and/or a remote processing device 108, and/or the cloud server 110 and/or the force sensing apparatus 114. For example, a non-transitory storage memory of one or more of the input unit 102, and/or a remote processing device 108, and/or the cloud server 110 and/or the force sensing apparatus can store a calibration model usable to calibrate the sensor readings obtained from the plurality of sensors 106. Alternatively or in addition, a non-transitory storage memory of one or more of the input unit 102, and/or a remote processing device 108, and/or the cloud server 110 and/or the force sensing apparatus can store a device IMU angle usable to correct IMU measurements from a device IMU.

A remote cloud server 110 may provide additional processing resources not available on the input unit 102, the remote processing device 108 or the force sensing apparatus 114. For example, some aspects of processing the sensor readings acquired by the sensors 106 may be delegated to the cloud server 110 to conserve power resources on the input unit 102, remote processing device 108 or force sensing apparatus 114. In some cases, two or more of the cloud server 110, input unit 102, remote processing device 108, and force sensing apparatus 114 may communicate in real-time to calibrate the force sensors 106, adjust the values of the sensor readings from the sensors 106 following calibration, and to provide timely feedback to a user regarding the sensor readings and other related data.

In the example system 100 illustrated in FIG. 1, a single input unit 102 is shown. However, system 100 may include multiple input units 102 associated with the same individual. For example, system 100 may include two separate input units 102, each input unit 102 associated with one of the individual's legs. Sensor data from an individual input unit 102 may be used for analysis of the force sensor data for the individual's corresponding leg. For example, the system 100 may operate with two input units 102 associated with a pair of footwear worn by a user.

Accordingly, the system 100 may include a separate sensing unit 105 (and a separate IMU where an IMU is included in system 100) for each foot of an individual. This may allow the force sensor data to be determined and calibrated separately for each of the individual's feet.

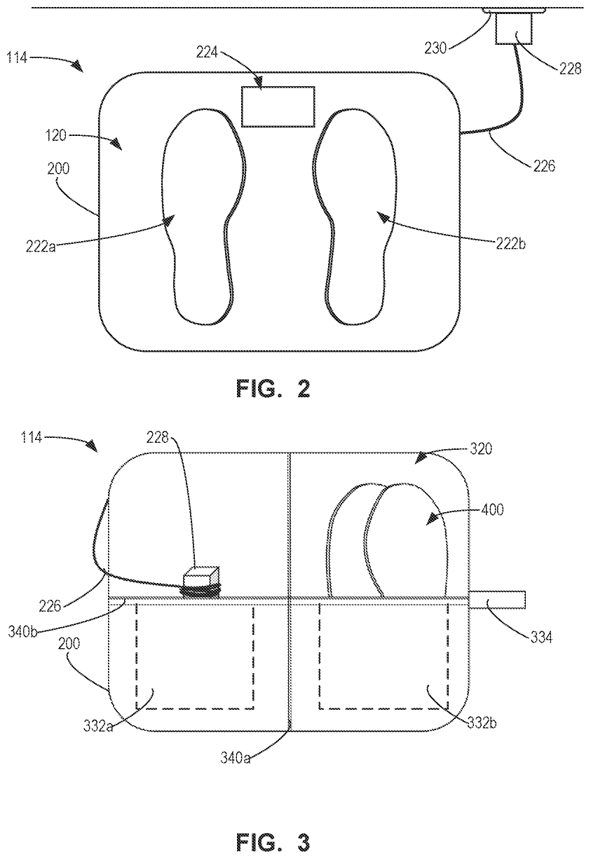

As noted above, the system 100 includes a force sensing apparatus 114. The force sensing apparatus 114 can include a plurality of apparatus force sensors 116a-116n. The plurality of apparatus force sensors 116 can be configured to sense a force applied to a surface of the force sensing apparatus 114. An example force sensing apparatus 114 is shown in FIGS. 2 and 3.

For example, an upper surface 120 of the force sensing apparatus 114 can be configured to receive a sensorized device worn by the user. The upper surface can be configured to receive a wearable device containing a sensing unit 105 while the wearable device is worn by a user. The force sensors 116 can thus be positioned below the upper surface 120 and arranged to sense a force applied to the upper surface 120 of the force sensing apparatus 114.

The plurality of apparatus force sensors 116 can be configured to sense applied forces with greater accuracy than the force sensors 106 contained in the sensing unit 105. Accordingly, where the force sensors 106 are worn underfoot while a user stands on the upper surface 120, the apparatus force sensors 116 can sense the force applied to the upper surface 120 with greater accuracy (i.e. relatively higher accuracy) than the plurality of device force sensors 106.

The plurality of force sensors 116 can be arranged in a sensor array across some or all of the force sensing apparatus 114. The plurality of apparatus force sensors 116 can be provided using various sensor systems, such as a force plate or electronic scale for example. Optionally, the apparatus force sensors 116 can be implemented using load cells and/or strain gauges. Alternatively, piezoelectric, capacitive, or other piezoresistive force sensors may be used as the force sensors 116.

The force sensing apparatus 114 can be used to calibrate the device force sensors 106 of the input unit 102. The force sensing apparatus 114 may operate as part of an inter-use calibration process. When the input unit 102 is positioned on the upper surface 120, the apparatus force sensors 116 can sense the force applied to the upper surface 120. The device force sensors 106 can concurrently sense the force being applied.

The measured values from the apparatus force sensors 116 and the device force sensors 106 can be compared. A calibration model can then be determined based on the comparison of the measured force values. The calibration model can be defined to adjust the sensed values from the device sensors 106 to match the force values sensed by the apparatus force sensors 116.

For example, a user can wear the input unit 102 underfoot (e.g. integrated into an insole as shown in the example of FIG. 4) when standing on the upper surface 120. The bodyweight sensed by the apparatus force sensors 116 and the device force sensors 106 can be compared. Calibration coefficients that are applied to the sensor readings from the device force sensors 106 can be adjusted until the bodyweight sensed by the device force sensors 106 matches the bodyweight sensed by the apparatus force sensors 116.

Optionally, the user can wear the input unit 102 underfoot when standing on the upper surface 120 in a plurality of different positions. The calibration model can then be determined based on the comparison of the measured force values for each different position. For example, a user may be instructed to stand in a variety of static stances (e.g. both feet flat, balance on the right toe, balance on the left heel, etc.) where the force applied to the apparatus force sensors 116 and the device force sensors 106 should be equivalent to the user's bodyweight. This may help improve the calibration of force sensors 106.

An example process 500 for calibrating force sensors that may be implemented using the force sensing apparatus 114 is described in further detail herein below with reference to FIG. 5.

As shown in the example of FIG. 1, the force sensing apparatus 114 can also include a charging unit 118. The charging unit 118 can be configured to charge the energy storage device onboard the input unit 102. Incorporating the charging unit 118 into the force sensing apparatus 114 can encourage a user to undergo the calibration process on a regular basis when recharging the input unit 102.

The charging unit 118 can be configured to charge the energy storage device of the input unit 102 when the input unit 102 is received on the upper surface 120.

Optionally, the charging unit 118 may be a wired charging unit. A user may connect an electrical connector between the charging unit 118 and the input unit 102 to charge the onboard energy storage device.

Alternatively, the charging unit 118 can be a wireless charging unit. This may simplify the process of positioning the input unit 102 for charging. This may also allow a user to position the input unit 102 in a desired location to be charged and to perform a calibration routine without having to remove or adjust the input unit 102. For example, the user need not connect a charging cable to input unit 102 in order to initiate charging.

The charging unit 118 can include a controller operable to control the charging of the energy storage device of the input unit 102. The charging unit 118 can also include a power supply. The power supply may include an electrical connector that is connectable to mains power (e.g. a standard wall adapter connectable to a power outlet). The charging unit 118 may also include additional power electronics (e.g. power conversion, voltage regulation etc.) necessary to charge the input unit 102. Optionally, the power supply can also be used to provide power to the plurality of apparatus force sensors 116.

In alternative examples, the power supply can a battery/power bank, to allow for portability of the force sensing apparatus 114. The battery/power bank can be recharged by mains power, using a removable electrical connector.

Various different types of wireless charging systems may be used in charging unit 118. The wireless charging unit can include one or more transmitter coils. The transmitter coils can be configured to provide electrical energy to input unit 102 to charge the onboard energy storage device.

Optionally, the transmitter coils may be located within the force sensing apparatus 114 at a specified charging location. That is, the input unit 102 may be required to be positioned within a defined portion of the upper surface 120 to enable charging of the energy storage device.

Alternatively, the charging unit 118 can be configured to enable charging of the input unit 102 across the entire upper surface 120.

Optionally, the charging unit 118 may include an inductive wireless charger. The inductive charger can include a plurality of transmitter coils. Each transmitter coil can charge the onboard energy storage device of an input unit 102 inductively when the input unit 102 is positioned on the upper surface 120 of the force sensing apparatus 114. For example, the charging unit 118 may include a pair of transmitter coils usable to charge a pair of input units 102 (e.g. a pair of sensorized footwear articles). The transmitter coils may have a defined position within the force sensing apparatus 114. Accordingly, the input unit 102 may need to be aligned with the defined charging position to ensure proper charging.

Alternatively, the charging unit 118 may include a resonant wireless charger. The resonant charger can include a single transmitter coil. The single transmitter coil can charge the onboard energy storage device of one or more input units 102 inductively when the input unit(s) 102 is/are positioned on the upper surface 120 of the force sensing apparatus 114. For example, the single transmitter coil may be usable to concurrently charge a pair of input units 102 (e.g. a pair of sensorized footwear articles).

The single transmitter coil of the resonant charger can be configured to generate a high frequency oscillating magnetic field. For example, a frequency of 10 MHz or greater may be used. The magnetic field can be defined to operate at the same resonant frequency as corresponding receiver coils in the input units 102. This may provide a user with greater flexibility to position the input unit 102 at various locations on the upper surface 120. The resonant charger may also allow a user to place the input unit 102 in various positions and orientations on the upper surface 120 so long as the receiver coils are parallel or substantially parallel with the transmitter coil.

Optionally, the charging unit 118 may be configured to detect the location and/or position of the input unit 102 on the upper surface 120. The charging unit 118 can be configured to adjust its output based on the detected location and/or position of the input unit 102. That is, the transmitter coil may emit an electromagnetic field of a frequency that is tuned to the position of the receiver coils with respect to the charging unit 118.

Optionally, the transmitter coil can be configured to detect the spacing of the insole to which it is coupled. The transmitter coil can then adjust its output accordingly, in order to effectively transfer energy at a given spacing. This can enable the charging unit in order to account for the variable nature of the spacing between the transmitter and receiver coils due to differing thicknesses of shoes. That is, when coupled to the input unit 102, the charging unit 118 can detect the spacing, and emit an electromagnetic field of a frequency that is tuned to the spacing.

To detect the insole spacing, the transmitter coil can be configured to emit a series of stimulation pulses to the receiver coil. The transmitter coil can receive a series of response pulses back from the receiver coil. The transmitter coil can then adjust the output of the transmitter coil based on the response pulses.

For example, the transmitter coil can be configured to transmit a series of stimulation pulses (also referred to as ‘pings’) in a narrow band that is close to the resonant frequency of the circuit. When these stimulation pulses are received by the receiver coil, response pulses are emitted by the receiver coil. The response pulses can then be detected by the transmitter coil. When the response pulses are detected, the transmitter coil can recognize the presence of the receiver coil in proximity to the transmitter coil. The transmitter coil can then emit pings with a broader band. The receiver coil can, in turn, continue to emit response pulses in response to the broader band pings. Based on the response pulses, the transmitter coil will determine an operating frequency (i.e. a highest efficiency frequency). The transmitter coil can then select that frequency and begin transferring energy at that frequency. For example, if the transmitter coil has a diameter of about 18 mm, and the transmitter coil and receiver coil are spaced apart by between about 1 mm and 18 mm, the operating frequency may be between about 0.43 MHz and 0.45 MHz.

Optionally, the force sensing apparatus 114 can include silicon and/or gallium nitride electronics, e.g. in examples where high frequency charging is used.

The charging unit 118 can be configured to charge one or more input units 102 at a given time. The number of input units 102 that can be charged at a given time can vary depending on the size and range of the transmitter coils and the size of the force sensing apparatus 114.

As noted above, the charging unit 118 may operate to charge an onboard energy storage device over a defined portion of the upper surface 120. Accordingly, an input unit 102 may need to be placed within the defined portion of the upper surface 120 to ensure proper charging.

Optionally, the electromagnetic field emitted from the transmitter coil can be dithered. That is, energy may be transferred at a frequency that oscillates slightly around the operating frequency, to reduce the peak emission of the system. This may help minimize or reduce conducted emissions from the charging unit 118.

Optionally, the charging unit 118 can be configured to detect the temperature in the vicinity of the transmitter coil. The charging unit 118 can then turn off the transmitter coil for a preset time period (e.g. about 20 seconds) if the temperature exceeds a predetermined threshold (e.g. a temperature of about 50 degrees Celsius). This can help mitigate issues caused by the generation of heat during charging.

Alternatively or in addition, the apparatus force sensors 116 may be positioned below a defined portion of the upper surface 120. That is, the apparatus force sensors 116 may only operate across a subset of the force sensing apparatus 114. Accordingly, an input unit 102 may need to be placed within the defined portion of the upper surface 120 to ensure that calibration can be performed.

Optionally, the upper surface 120 can include an alignment guide. The alignment guide can be a visual indication of the defined portion of the upper surface 120 upon which the input unit 102 is receivable to undergo charging by the charging unit 118 or to perform a calibration. For example, as shown in FIG. 2, an alignment guide 222a/222b can identify the position for one or more input units 102 on the upper surface 120 by providing an outline of the input unit 102. Alternatively or in addition, the alignment guide can include one or more mechanical alignment features such as a set of grooves usable to guide a user in placing the input unit 102 on the upper surface 120. Alternatively or in addition, the force sensing apparatus 114 and input unit 102 may contain magnets to assist with proper alignment.

Optionally, the alignment guide 222 may also specify an orientation for the input unit 102. This may be required, for example, where the receiver coils in the input unit 102 need to be aligned with the transmitter coils of the charging unit 118.

The alignment guide 222 may also allow the apparatus force sensors 116 to be clustered proximate to the defined portion of the upper surface 120. That is, the apparatus force sensors 116 may not necessarily span the entire apparatus 114. Instead the force sensors 116 may be positioned below the upper surface 120 and in alignment with the alignment guide(s) 222.

Alternatively, the apparatus force sensors 116 may be positioned throughout the force sensing apparatus 114. This may allow calibration to occur when the input unit 102 is not properly aligned for charging and/or in the absence of an alignment guide 222.

Optionally, the force sensing apparatus 114 can include an operational indicator. The operational indicator can indicate that the force sensing apparatus 114 is performing a calibration routine and/or charging an input unit 102. The operational indicator can be provided as various different outputs, such as a visual and/or audible and/or haptic output.

Optionally, a plurality of operational indications may be provided relating to one or more of a connectivity status, charging status, and/or calibration status. For example, different outputs may be provided to indicate varied levels of charging (e.g. an LED display that changes colors as the input unit 102 is charged).

Optionally, the operational indicator may include a visual indicator 224. The visual indicator 224 may indicate that an input unit 102 is undergoing charging by the charging unit 118. Alternatively or in addition, the visual indicator 224 may indicate that an input unit 102 is being calibrated by the charging unit 118. The visual indicator 224 may include various different outputs corresponding to different operational statuses (e.g. charging, calibrating, etc.).

Optionally, the force sensing apparatus 114 can also provide instructional outputs to a user. For example, an instructional output can be provided to instruct a user to stand on the upper surface 120 to perform a calibration and/or indicate that the calibration is completed.

Optionally, the force sensing apparatus 114 can also include various additional outputs. For example, the force sensing apparatus 114 may provide a visual display indicative of the mass detected by the apparatus force sensors 116 (i.e. to operate as an electronic scale).

As shown in the example of FIGS. 2 and 3, the force sensing apparatus 114 can include a housing 200. The housing 200 can be configured to contain the plurality of apparatus force sensors 116 and the charging unit 118. An interior portion of the housing 200 can enclose the plurality of apparatus force sensors 116 and the charging unit 118. The housing 200 can also define the upper surface 120 of the force sensing apparatus 114 (e.g. an outer surface of the housing 200 can provide the upper surface 120).

In the example shown in FIGS. 2-3, the force sensing apparatus 114 is provided in the form of a mat. The housing 200 can define the exterior portion of the mat on which a user can stand. This can provide a combined system for calibration and charging that is convenient for a user in order to encourage frequent calibration.

Various different types of materials can be used to provide the housing 200, including rigid materials such as plastic or metal or compressible materials such as rubber, foam, and other materials often used in “smart” bathmats.

The apparatus force sensors 116 and the charging unit 118 can be arranged within the housing 200 to enable an input unit 102 to be calibrated while positioned on the upper surface 120 and to enable the input unit 102 to be charged while positioned on the upper surface 120. For example, the force sensors 116 (and associated electronics) and charging unit 118 can be positioned in a stacked arrangement (e.g. with one on top of the other) within the housing 200.

Optionally, the charging unit 118 can be positioned between the plurality of apparatus force sensors 116 and the upper surface 120. That is, the charging unit 118 may be located closer to the upper surface 120 than the apparatus force sensors 116. This may be particularly advantageous for a wireless charging unit in order to minimize the distance between the transmitter coils of the charging unit 118 and receiver coils of the input unit 102.

Optionally, the charging unit 118 and force sensors 116 can have shared electronic components. For example, the charging unit 118 and force sensors 116 may share a power supply (e.g. electrical connector 226 and adapter 228 that are connectable to mains power 230). This may help reduce the size and complexity of the force sensing apparatus 114.

Alternatively, the charging unit 118 and force sensors 116 may have completely independent electronic components. This may allow the force sensing apparatus 114 to continue calibrating or charging even where there is a failure in the electronics associated with one of the charging unit 118 and force sensors 116.

Optionally, the force sensing apparatus can include electromagnetic interference (EMI) shielding between at least a portion of the charging unit 118 and the force sensors 116. For example, an electronics module associated with the apparatus force sensors 116 may be shielded from the transmitter coil(s) of the charging unit 118. The shielding can be arranged within the housing 220 to shield the electronics module from the electromagnetic field generated during charging of the input unit 102 by the charging unit 118. For example, the shielding may be provided by positioning a ferrite between the transmitter coil(s) and the electronics module of the force sensors 116.

The force sensing apparatus 114 can include a processor configured to communicate with the input unit 102, processing device 108 and/or cloud server 110. The force sensing apparatus 114 can be configured to communicate with other devices wirelessly, e.g. using wireless communication protocols such as Bluetooth or Wi-Fi for example.

Optionally, a calibration application may be provided through the processing device 108 and/or cloud server 110 to output data to a user relating to charging and/or calibration of an input unit 102. For example, the calibration application may be a mobile application operable on a portable processing device such as a smartphone.

The calibration application can provide calibration instructions to a user (e.g. instructions to stand on the upper surface 120 for a defined period of time such as 30 second) to perform a calibration of input unit 102. Alternatively or in addition, the calibration application can provide charging status data to a user, such as the current charge state of the input unit 102 and/or a connectivity status of the input unit 102 (for charging and/or calibration).

The force sensing apparatus 114 can be configured to perform charging and calibration operations separately/independently and/or (at least partially) concurrently.

The force sensing apparatus 114 can be configured to charge an input unit 102 when the input unit 102 is positioned on the upper surface 120 regardless of whether the input unit 102 is worn by a user. For example, a user may position the input unit 102 on the upper surface 120 when the input unit 102 is not being worn in order to charge the input unit 102 without performing a calibration. The input unit 102 can then be charged automatically using charging unit 118 (so long as the input unit 102 is positioned to enable connectivity between the charging unit 118 and the onboard energy storage device). Upon completion of charging, the user can remove the input unit 102 from the upper surface 102 if desired. The user is not required to stand on the upper surface 120 at any point in order to charge the input unit 102.

The force sensing apparatus 114 can be configured to calibrate an input unit 102 when the input unit 102 is positioned on the upper surface 120 while being worn by a user. The user can step onto the upper surface 120 while wearing a wearable device containing the sensors 106. The user can remain on the upper surface 120 for a defined calibration period (e.g. 30 seconds). During the calibration period, the apparatus force sensors 116 and device force sensors 106 can obtain sensor readings. The sensor readings can be compared and used to determine a calibration model for the input unit 102.

Typically, the calibration period can be less than the period required to recharge the onboard energy storage device. Accordingly, the user may perform a calibration of the input unit 102 with little or no charging of the onboard energy storage device.

Optionally, the force sensing apparatus 114 can be configured to charge the energy storage device of input unit 102 using charging unit 118 while concurrently operating the apparatus force sensors to sense the force applied to the upper surface 120. Accordingly, calibration and charging of the input unit 102 may be performed substantially simultaneously. This may be desirable, for instance, when a user has completed an activity using the input unit 102 or is preparing to begin a new activity.

Optionally, a reference force value for the user can also be updated during the calibration period (e.g. by measuring the user's bodyweight using the apparatus force sensors 116). The reference force value can be stored in a non-transitory memory of the input unit 102, processing device 108 and/or cloud server 110 for use as part of an intra-use calibration process such as the example process 600 described in further detail herein below. Accordingly, it may be desirable to perform a calibration of the input unit 102 when the user is preparing to begin a new activity to ensure that the reference force value is accurate. This can ensure that the reference value reflects the user's bodyweight inclusive of clothing and daily weight fluctuations at least at the time the activity begins.

Optionally, the force sensing apparatus 114 can also be configured to perform additional force sensing operations, such as operating as an electronic scale. For example, a user may stand on the upper surface 120 without wearing an input unit 102 and the force sensing apparatus 114 can output the user's mass.

Optionally, the force sensing apparatus 114 can include an apparatus inertial measurement unit (IMU). The apparatus IMU can be used to determine an angular position of a device IMU contained in the input unit 102. The input unit 102 can typically be integrated into a wearable device in the form of footwear or an insert that sits in footwear. Due to the shape and/or contouring of the particular wearable device and/or footwear, the device IMU in the input unit 102 may be positioned at different angles. Accordingly, the angle of the apparatus IMU can be compared to the angle of the device IMU of the input unit 102 to determine a device IMU angle. The device IMU angle can then be used to adjust the measurements from the device IMU to ensure that the IMU measurements reflect the actual angular orientation of the IMU. This can help improve the accuracy of metrics derived wholly or in part from IMU measurements.

Optionally, the force sensing apparatus 114 can be portable. This may allow a user to easily transport the force sensing apparatus 114 to ensure that the input unit 102 can be calibrated and/or charged at different locations. For example, the force sensing apparatus 114 may have a size and weight similar to a typical electronic scale.

The force sensing apparatus 114 can also be configured to facilitate portability of the force sensing apparatus 114 and/or the input unit 102. For example, the force sensing apparatus 114 may be foldable. For example, the force sensing apparatus 114 may be foldable along fold lines 340a and 340b shown in FIG. 3. This may allow the force sensing apparatus 114 to convert between a more compact storage position (not shown) and an operational position (e.g. as shown in FIGS. 2 and 3).

Optionally, the force sensing apparatus 114 can include one or more receptacles. A receptacle can be defined to allow a wearable device containing the input unit 102 to be received when the wearable device is not being worn by a user. Alternatively or in addition, the receptacle can allow additional components of the force sensing apparatus (e.g. adapter 228) or accessories to be stored in the force sensing apparatus 114.

For example, the force sensing apparatus 114 can include one or more receptacles or pockets 332. As shown in the example of FIG. 3, the force sensing apparatus can include a pair of receptacles 332a and 332b, although a greater or fewer number of receptacles may be provided. The receptacles 332 can be formed as pockets on the back or bottom surface 320 of the force sensing apparatus 114.

The force sensing apparatus 114 can also include additional features to facilitate transportability. For example, the force sensing apparatus 114 can include one or more fasteners 334 usable to secure the force sensing apparatus 114 in the storage position. The fastener 334 can be provided in various forms, such as a removable adhesive, a hook and loop fastener, a buckle, a string (e.g. that can be tied) and so forth.

The force sensing apparatus 114 may also include one or more carrying supports such as a strap or handle to facilitate transportation by a user. The strap may be used to carry the force sensing apparatus 114 in a storage position or even in an operational position.

Though the force sensing apparatus 114 is shown as a single device in FIGS. 2 and 3, alternatively, it may be separated into two devices—i.e. one for each sensorized insole. This may be beneficial for calibration, as this will eliminate the need for any processing required to determine which foot activated the force sensors in the force sensing apparatus.

Referring now to FIG. 4, shown therein is an example of an insole 400 that includes a sensing unit 402. The insole 400 is an example of an input device 102 that may be used in the system 100 shown in FIG. 1. The insole 400 may be the footwear insert described in PCT Application No. PCT/CA2020/051520, the entirety of which is incorporated herein by reference.

Optionally, the sensing unit 402 can include an IMU (not shown). The sensor unit 402 can also include at least one connector 406. The connector 406 may provide a coupling interface between the plurality of sensors 106 (and the optional inertial measurement unit) and an electronics module (not shown) such as electronics module 104. The coupling interface can allow signals from the sensors 106 and/or IMU to be transmitted to the electronics module. In some cases, the coupling interface may also provide control or sampling signals from the electronics module to the sensors 106 and/or IMU.

The arrangement of sensors 106 in the sensor unit 402 is an example of a sparse sensor array that may be used to collect force sensor data. In alternative examples, various different types of force sensors, force sensor arrays, and arrangements of force sensors may be used. For example, sensor units containing a dense force sensor array (e.g. a Pedar® insole with 99 sensors or Tekscan® system) may also be used.

Incorporating the sensor unit 402 in a wearable device such as insole 400 may provide a number of advantages. Fitness equipment equipped with sensors, such as force-instrumented treadmills, are often expensive and may require specialized installation. By contrast, including the sensor unit 402 in a wearable device (e.g. an insole 400) does not require any special installation or modifications to the fitness equipment used by an individual.

Incorporating the sensing system into a wearable device may help reduce the cost of the sensing system. Furthermore, the wearable device may allow an individual to measure force and other sensor data (e.g. IMU sensor data) while performing various activities including running, walking, jumping, cycling, gaming etc. This can further offset the cost of the sensing system, as a single sensing system may be used for multiple activities, rather than requiring separate specialized sensing systems for each activity.

Referring now to FIG. 5, shown therein is an example method 500 for calibrating a plurality of force sensors in a wearable device worn by a user. The plurality of force sensors are positioned underfoot of the user in the wearable device. The method 500 may be used with a plurality of sensors configured to measure human movement or human activity, such as sensors 106. Method 500 is an example of a method for analyzing force sensor data in which force sensors in a wearable device are calibrated using a combined force sensing and charging system such as force sensing apparatus 114 that can also charge an energy storage device associated with the force sensors.

At 510, sensor readings can be obtained from a wearable device. The sensor readings can include a first plurality of measured sensor readings from a plurality of force sensors while the wearable device is worn by the user while standing on an upper surface of a force sensing apparatus such as force sensing apparatus 114. For example, the sensor readings can be obtained while a user is standing on the upper surface 120 of force sensing apparatus 114 while wearing a wearable device that includes the input unit 102.

The sensors can include a plurality of force-sensing elements (force sensors) positioned underfoot. The force sensors can be configured to acquire force sensor data at locations underneath an individual's foot for one or both of the individual's lower limbs.

Optionally, the plurality of sensors in the input unit can also include one or more IMUs. Accordingly, the plurality of sensor readings acquired at 510 can include IMU sensor data received from the one or more IMUs.

Each inertial measurement unit (IMU) can be associated with the plurality of force sensors. For example, the IMU may be incorporated into the same wearable device as the plurality of force sensors. More generally, the IMU can be configured to collect IMU sensor data about a single lower limb of an individual. This IMU sensor data can be acquired for the same lower limb for which the sensor readings were obtained from the plurality of force sensors.

The sensor readings acquired at 510 may be acquired as a time-continuous set of sensor readings. This may provide a time-continuous set of sensor data that can be used to calculate force values on a time-continuous basis (e.g. determining time-continuous force) and/or as discrete data values (e.g. a peak force value, an average force value). Depending on the nature of the sensors and the signal preprocessing performed, the time-continuous sensor data may be discretized, e.g. using an analog to digital conversion process. Even where the sensor data is discretized, the set of sensor data may allow the force value to be determined as (discretized) time-continuous values or discrete values.

Optionally, data collection can be initiated by the user directly. For example, the sensor readings can be obtained in response to a user initiating a sensor collection session, e.g. through a mobile application on their mobile device. A user can initiate a data collection session while wearing the wearable device and standing on the upper surface of a force sensing apparatus. Sensor data can then be collected from the sensors in the wearable device while the user stands on the upper surface.

Alternatively or in addition, data collection may be initiated automatically by the input unit 102 and/or force sensing apparatus 114. For example, the data collection may be initiated in response to determining that the input unit 102 is wirelessly connected to the force sensing apparatus 114.

Optionally, the force sensing apparatus 114 and/or input unit 102 may generate a prompt for the user to confirm that data collection should begin. For example, the prompt can be transmitted to a user to confirm the initiation of a sensor collection session, e.g. through a mobile application on their mobile device. This can allow the user to confirm that they are standing on the upper surface of the force sensing apparatus in order to perform the calibration process.

Optionally, the wearable device may be aligned with a defined portion of the force sensing apparatus 114 prior to collecting the sensor readings at 510. For example, the input unit 102 may be aligned with a defined portion of the upper surface 120 of the force sensing apparatus 114 prior to obtaining the sensor readings at 510. This may ensure that the apparatus force sensors are capable of obtaining concurrent sensor readings at 520.

As noted above, the force sensing apparatus can also be configured to charge an energy storage device of the wearable device when the wearable device is received on the upper surface. Optionally, the energy storage device can be charged concurrently while the first plurality of measured sensor readings (and second plurality of measured sensor readings) are obtained at 510 (and 520).

Alternatively, the energy storage device can be charged at a time other than when the first plurality of measured sensor readings are obtained. This may ensure that there is no interference between the charging unit 118 and the electronics of the force sensors 116.

At 520, sensor readings can be obtained from apparatus force sensors in the force sensing apparatus. The sensor readings obtained at 520 can be a second plurality of measured sensor readings obtained from a plurality of apparatus force sensors while the wearable device is worn by the user while standing on the upper surface.

The sensor readings obtained at 520 can be obtained in generally the same format as those obtained at 510. The second plurality of measured sensor readings can also be obtained concurrently with the first plurality of measured sensor readings. This can ensure that the force values being measured by the device force sensors and the apparatus force sensors are in response to the same applied force. Optionally, the input unit 102 and force sensing apparatus 114 may perform a synchronization process to ensure that the first and second plurality of sensor readings can be correlated in time.

At 530, a first measured force value can be determined. The first measured force value can be determined based on the first plurality of measured sensor readings from 510. The first measured force value can thus represent a device force value indicative of the force measured by the force sensors in the wearable device.

The first measured force value can be determined in various ways. For example, the force value may be determined directly as a force sensor value sensed by an individual force sensor and/or a combined force sensor value applied over all of the force sensors within an input unit 102. Alternatively, the force value can be determined as a derived force value determined from the sensor readings (e.g. a user bodyweight, a vertical ground reaction force, a center of pressure, etc.).

At 540, a second measured force value can be determined. The second measured force value can be determined based on the second plurality of measured sensor readings from 530. The second measured force value can thus represent an apparatus force value indicative of the force measured by the apparatus force sensors in the force sensing apparatus. The second measured force value can generally be determined as the same type of value (e.g. force sensor value, bodyweight, ground reaction force, center of pressure etc.) as the first measured force value.

The apparatus force sensors can typically be sensors with a higher expected accuracy than the sensors in the wearable device. Accordingly, the second measured force value can provide an inter-use reference value usable to calibrate the force sensors in the wearable device.

At 550, a calibration model can be determined for the plurality of force sensors by comparing the first measured force value (from 530) and the second measured force value (from 540). For example, the bodyweight measured by the plurality of apparatus force sensors and the bodyweight measured by the plurality of device sensors can be compared for a user. Any difference in the measured bodyweight(s) can be used to determine a calibration model to adjust the sensor readings from the device sensors.

The calibration model may include a plurality of calibration coefficients. The calibration coefficients can be defined to adjust the sensor readings obtained from the device sensors (e.g. by multiplying the sensed values by the respective calibration coefficients). For example, the plurality of calibration coefficients can include a sensor-specific calibration coefficient for each sensor in the plurality of sensors in the input unit 102. The sensor readings from each sensor can then be adjusted using the respective calibration coefficient.

Optionally, the calibration model can include a lookup table. The lookup table can be defined to adjust the sensor readings obtained from the device sensors (e.g. by multiplying the sensed values by the values in the lookup table).

The calibration model may be determined in an iterative process. For example, an initial calibration model may be defined for the device sensors. The first measured force value can then be updated using the initial calibration model. The updated first measured force value can then be compared to the second measured force value. This process may be repeated multiple times until the first measured force value matches the second measured force value. The updated calibration model can then be defined as the calibration model for the input unit 102.

Optionally, the calibration model can be determined at 550 based on a plurality of comparisons of measured force values (e.g. by repeating steps 510-540 multiple times). For example, a user may stand on the upper surface 120 in a plurality of different positions while wearing the input unit 102 underfoot. The plurality of positions may include a plurality of different static stance positions (e.g. both feet flat, balance on the right toe, balance on the left heel, etc.). Steps 510-540 can be repeated for each position in the plurality of positions. The calibration model can then be determined at 550 based on comparisons of the first measured force value (from 530) and the second measured force value (from 540) for each different position. This can help improve the calibration of the force sensors 106.

For example, an error value (e.g. a root-mean square error) for each position can be determined based on the comparison of the first measured force value (from 530) and the second measured force value (from 540) for that position. The calibration model can then be determined to minimize the error value of all of the different comparisons (i.e. minimize the error value for all of the different positions). For example, a cost function may be applied to determine a lowest combined error value and/or a minimum error value for each different position.

The calibration model determined at 550 can then be output. For example, the calibration model can be output for storage in a non-transitory storage memory of the input unit 102, a processing device 108, cloud server 110 and/or force sensing apparatus 114. The stored calibration model can subsequently be used to adjust the sensor readings obtained by the input unit 102.

Optionally, the calibration model can be stored in a non-transitory storage memory contained within the wearable device. This may allow the sensor readings to be adjusted in real-time by the input unit 102 to allow for real-time feedback to the user.

Optionally, method 500 may further include a sub-process for determining an IMU orientation. As noted above, the input unit 102 may include an optional device IMU. The force sensing apparatus can also include an apparatus IMU. An angle of the apparatus IMU can be compared with an angle of the device IMU to determine the angular orientation of the device IMU.

The IMU calibration sub-process can include obtaining a first IMU angle measurement from a wearable device IMU provided by the wearable device while the wearable device is worn by the user while standing on the upper surface. A second IMU angle measurement can be obtained from an apparatus IMU of the force sensing apparatus. The first IMU angle measurement and the second IMU angle measurement can be concurrent angle measurements. A device IMU angle for the wearable device IMU can be determined by comparing the first IMU angle measurement and the second IMU angle measurement. The device IMU angle can be used to orient the IMU measurements from the device IMU to ensure that IMU-derived metrics are calculated accurately.

The device IMU angle (or an angle adjustment factor) can then be output. For example, the device IMU angle can be output for storage in a non-transitory storage memory of the input unit 102, a processing device 108, cloud server 110 and/or force sensing apparatus 114. The stored device IMU angle can subsequently be used to adjust the IMU measurements obtained by the input unit 102.

Optionally, the device IMU angle can be stored in a non-transitory storage memory contained within the wearable device. This may allow the IMU measurements to be adjusted in real-time by the input unit 102 to allow for real-time feedback to the user.

Referring now to FIG. 6, shown therein is an example method 600 for calibrating force sensor data from a plurality of force sensors positioned underfoot. The method 600 may be used with a plurality of sensors configured to measure human movement or human activity, such as sensors 106. Method 600 is an example of a method for analyzing force sensor data in which force sensor data is calibrated while a user is performing an activity.

The example method 600 is an example of an intra-use calibration process that can occur while a user is performing an activity while wearing the wearable device. The intra-use calibration process requires an initial reference value (e.g. the user's bodyweight) to be known. For example, the initial reference value can be measured using the device force sensors 106 (e.g. while a user is standing still), input manually by a user, or measured using a different device (e.g. using the apparatus force sensors 116 while a user is standing on the upper surface 120).

At 610, a plurality of measured sensor readings can be obtained from the plurality of force sensors. The sensor readings can be obtained while the wearable device is worn by the user while performing a particular action. The sensor readings can be obtained in generally the same manner as described above at 510.

At 620, at least one force measurement value corresponding to the particular action can be determined based on the plurality of measured sensor readings at 610.

Sensor readings from the plurality of force sensors can be collected on an ongoing basis. The sensor readings may be analyzed to detect a particular action or position, such as a standstill position or a user walking on one leg following the double support phase of walking. When individuals stand still they typically exert a force equivalent to body weight combined between both their legs. When individuals walk, they typically exert a force equivalent to body weight on one leg following the double support phase of walking. The sensor readings obtained while the user is performing the particular action or in the particular position can then be used at 620 to determine at least one force measurement value.

Different types of force measurement values may be determined depending on the type of calibration being performed. For example, the at least one force measurement value may be an aggregate force value determined from the plurality of measured sensor readings. This can be determined as a sum of the force values generated from the sensor readings from all sensors. This may be useful in identifying and correcting sensor drifts or changes due to changes in the environmental conditions.

Alternatively, the at least one force measurement value can be a single sensor force value determined using measured sensor readings from a single force sensor in the plurality of force sensors. This may be useful in correcting sensor readings from a single force sensor.

At 630, a calibration model can be determined by comparing the at least one force measurement value to at least one expected force value. The calibration model can be determined to minimize a difference between the at least one force measurement value and the at least one expected force value.

The calibration model can be determined to include one or more calibration coefficients. The calibration coefficient(s) can be defined to adjust the sensor readings obtained from the device sensors (e.g. by multiplying the sensed values by the respective calibration coefficients). For example, the calibration coefficient(s) can include a sensor-specific calibration coefficient for each sensor. The sensor readings from each sensor can then be adjusted using the respective calibration coefficient.

The at least one expected force value may be a known bodyweight of the user. The at least one force measurement value may be an aggregate force value determined from the plurality of measured sensor readings. The calibration model can then be determined by comparing the aggregate force value to the known bodyweight of the user. The calibration model can be determined to result in a calibrated aggregate force value that matches the known bodyweight of the user. The calibration model can be determined in generally the same way as described at step 550 of method 500.

Optionally, as noted above at 520, the at least one force measurement value may be a single sensor force value determined using measured sensor readings from a single force sensor in the plurality of force sensors. In such cases, the at least one expected force value may include a plurality of neighboring sensor force values. Each neighboring sensor force value can be determined using measured sensor readings from a neighboring force sensor that neighbors the single force sensor in the plurality of force sensors. The calibration model may then include a single sensor calibration coefficient corresponding to the single force sensor.

A single sensor force value can be used to compare the sensor readings from individual sensors to the sensor readings from neighboring sensors to detect variations.

This can be performed, for example, at times when the measured force should be the same (e.g. during the swing phase of a gait cycle). Deviations between the sensor readings from neighboring sensors can be identified, and the deviant sensors can be recalibrated to match the force values detected by the neighboring sensors. Automatic zeroing and single sensor calibration using neighbouring sensors can be used to calibrate sensors that measure shear force, in addition to sensors that measure normal force

For example, during the swing phase of the gait cycle, the measured normal and shear force should be zero. If the sensors measure a non-zero value, they can be corrected with automatic zeroing. Likewise, if one sensor detects a different normal or shear force than its neighboring sensors, the forces measured by its neighboring sensors can be used to correct the drifting sensor.

Intra-use calibrations can also be performed to correct for sensor drift. As noted above, for example, the measured values at specified times can be compared to known reference values to correct for drift.

Alternatively or in addition, automatic zeroing can be applied to adjust the sensor readings when a user is performing a particular action that should result in no force being sensed (e.g. during the swing phase of a gait cycle).

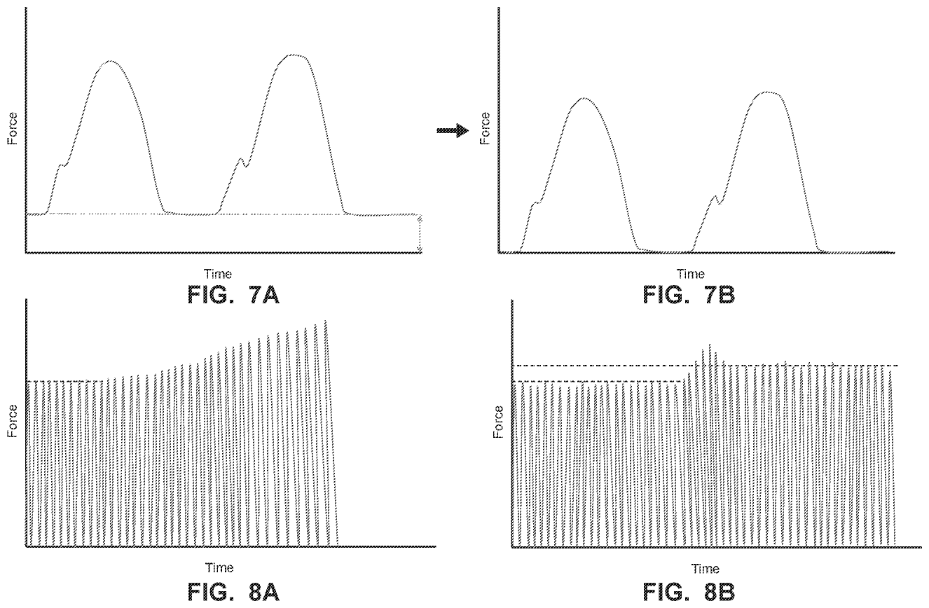

FIG. 7A illustrates an example plot of force during a gait cycle. As shown in FIG. 7A, the force is non-zero even during the swing phase. Accordingly, the sensors are experiencing a drift offset. The drift offset can be identified as being the non-zero value detected during the swing phase. This drift offset value can then be subtracted from all of the sensor readings to provide a drift corrected force value as shown in FIG. 7B.

The swing phase may be detected based on the sensor readings from 610 and in some cases using IMU measurements. An example method of scaling a drifted force signal with an IMU is described in co-pending U.S. patent application Ser. No. 17/991,501 the entirety of which is incorporated herein by reference.

Drift correction may also be performed based on peak force values detected during a cyclic activity. When an individual performs a cyclic activity at steady state speed (running, cycling, etc.) and the external conditions do not change while they perform the activity (e.g. a person runs along a flat track), the peak forces should remain relatively consistent throughout the activity. If the peak forces start to change (e.g. linearly increase) as the activity progresses, this is indicative that sensor drift has occurred. FIG. 8A shows an example plot of peak forces during a cyclic activity. As shown in FIG. 8A, the peak forces experience a linear increase over the course of the cyclic activity. When a change in the peak force value is detected, the drift can be corrected based on the peak force value prior to the detected change.

If the external conditions change while a user is performing the activity (e.g. if a person switches from running on grass to running on concrete), the peak force values are expected to show discontinuities over time. These discontinuities can be identified in the force signal (see e.g. FIG. 8B). However, following the discontinuity, if the external conditions cease to change further, the peak forces should again settle to a constant value as shown in FIG. 8B (which may be different from the constant value under the initial conditions).

Optionally, Kalman filtering can also be used to improve sensor measurements made by the input units 102 and to correct for sensor drift. Kalman filtering involves the use of a prediction-correction model used for linear and time-variant or time-invariant systems. The prediction-correction model can be applied to resolve measurement error from sensor data, such as sensor data obtained by input unit 102. Kalman filtering involves the use of an additional measurement source such as the force sensing unit 114 and/or an alternative measurement source (e.g. a GPS tracker) in addition to the input unit 102. For example, data obtained from a GPS tracker monitoring movement of the input unit 102 can be used to iteratively correct estimated values (e.g. distance measurements, stride velocity, etc.) that are determined based on IMU sensor data received from the one or more IMUs in the input unit 102. As another example, the force sensing unit 114 can be used to improve vertical ground reaction force estimates determined based on sensor data from the force sensors 106.

The calibration model determined at 630 can then be output. For example, the calibration model can be output for storage in a non-transitory storage memory of the input unit 102, a processing device 108, cloud server 110 and/or force sensing apparatus 114. The stored calibration model can subsequently be used to adjust the sensor readings obtained by the input unit 102.

Method 600 can be used independently of the force sensing apparatus 114 and method 500. However, it may be preferable to perform method 600 in conjunction with the force sensing apparatus 114 and/or the inter-use calibration method 500. This may ensure that the initial reference value is accurate and accounts for fluctuations in the user's bodyweight. In addition, the inter-use calibration method 500 can be used to correct drift in the sensors 106.

The intra-use calibration process 600 can be used to recalibrate the sensors 106 between inter-use calibrations performed using force sensing apparatus 114. An example of a combined calibration routine can involve a user calibrating the sensors 106 using the force sensing apparatus 114 (e.g. through method 500). As part of this inter-use calibration, the user's bodyweight can be measured. The user can then begin performing an activity. While performing their activity, if a specified position or motion is detected, the total force detected by sensors 106 can be calculated and compared to the user's bodyweight detected by the force sensing apparatus 114. The sensors 106 can then be recalibrated to match the user's bodyweight detected by the force sensing apparatus 114 during the initial inter-use calibration routine.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A system for calibrating a plurality of force sensors in a wearable device worn by a user, wherein the plurality of force sensors are positioned underfoot, the system comprising:
a force sensing apparatus comprising an upper surface and a plurality of apparatus force sensors, wherein the upper surface is configured to receive the wearable device while the wearable device is worn by the user, the plurality of apparatus force sensors are arranged below the upper surface, and the plurality of apparatus force sensors are configured to sense a force applied to the upper surface;
a charging unit operable to charge an energy storage device of the wearable device when the wearable device is received on the upper surface;
one or more processors in communication with the wearable device; and
a non-transitory storage memory;
wherein the one or more processors are configured to
determine a first measured force value, wherein the first measured force value is determined based on a first plurality of measured sensor readings from the plurality of force sensors while the wearable device is worn by the user while standing on the upper surface;
determine a second measured force value, wherein the second measured force value is determined based on a second plurality of measured sensor readings from the plurality of apparatus force sensors while the wearable device is worn by the user while standing on the upper surface; and
determine a calibration model for the plurality of force sensors by comparing the first measured force value and the second measured force value.

2. The system of claim 1, wherein the force sensing apparatus further comprises an apparatus inertial measurement unit (IMU) and the one or more processors are configured to:
obtain concurrent first IMU angle measurement and second IMU angle measurement, wherein the first IMU angle measurement is obtained from a wearable device IMU provided by the wearable device while the wearable device is worn by the user while standing on the upper surface and the second IMU angle measurement is obtained from the apparatus IMU;
determine a device IMU angle for the wearable device IMU by comparing the first IMU angle measurement and the second IMU angle measurement; and
output the device IMU angle.

3. The system of claim 1, wherein the one or more processors are configured to store the calibration model in the non-transitory storage memory, wherein the non-transitory storage memory is contained within the wearable device.

4. The system of claim 1, wherein the wearable device is an insole.

5. The system of claim 1, wherein the force sensing apparatus is portable and foldable.

6. The system of claim 1, wherein the force sensing apparatus further comprises a receptacle within which the wearable device is receivable when the wearable device is not being worn by the user.

7. The system of claim 1, wherein the charging unit is operable to charge the energy storage device, and the plurality of apparatus force sensors are concurrently operable to sense the force applied to the upper surface when the wearable device is received on the upper surface.

8. The system of claim 1, wherein the charging unit is a wireless charging unit.

9. The system of claim 1, wherein the charging unit is operable to charge the wearable device over a defined portion of the upper surface and the upper surface includes an alignment guide indicating the defined portion of the upper surface upon which the wearable device is receivable to undergo charging by the charging unit.

10. The system of claim 1, further comprising a housing containing the plurality of apparatus force sensors and the charging unit, the housing defining the upper surface.

11. The system of claim 10, wherein the force sensing apparatus comprises an electronics module associated with the plurality of apparatus force sensors, the charging unit comprises a transmitter coil, and the housing further comprises shielding arranged to shield the transmitter coil from the electronics module.

12. A method of calibrating a plurality of force sensors in a wearable device worn by a user, wherein the plurality of force sensors are positioned underfoot, the method comprising:
determining a first measured force value, wherein the first measured force value is determined based on a first plurality of measured sensor readings from the plurality of force sensors while the wearable device is worn by the user while standing on an upper surface of a force sensing apparatus, wherein the force sensing apparatus comprises a plurality of apparatus force sensors arranged below the upper surface and the plurality of apparatus force sensors are configured to sense a force applied to the upper surface;
determining a second measured force value, wherein the second measured force value is determined based on a second plurality of measured sensor readings from a plurality of apparatus force sensors while the wearable device is worn by the user while standing on the upper surface; and
determining a calibration model for the plurality of force sensors by comparing the first measured force value and the second measured force value.

13. The method of claim 12, wherein the force sensing apparatus further comprises an apparatus inertial measurement unit (IMU) and the one or more processors are configured to:
obtain a first IMU angle measurement from a wearable device IMU provided by the wearable device while the wearable device is worn by the user while standing on the upper surface;
obtain a second IMU angle measurement from an apparatus IMU of the force sensing apparatus, wherein the first IMU angle measurement and the second IMU angle measurement are concurrent;
determine a device IMU angle for the wearable device IMU by comparing the first IMU angle measurement and the second IMU angle measurement; and
output the device IMU angle.

14. The method of claim 12, wherein the force sensing apparatus is portable and foldable.

15. The method of claim 12, further comprising charging an energy storage device of the wearable device when the wearable device is received on the upper surface.

16. The method of claim 15, wherein the energy storage device is charged concurrently while the first plurality of measured sensor readings are obtained.

17. The method of claim 15, wherein the energy storage device is charged at a time other than when the first plurality of measured sensor readings are obtained.

18. The method of claim 15, wherein the energy storage device is charged wirelessly.

19. The method of claim 15, further comprising aligning the wearable device with a defined portion of the upper surface using an alignment guide, wherein the defined portion is a region of the upper surface upon which the wearable device is receivable to undergo charging.

20. The method of claim 15, further comprising outputting a visual indicator while the wearable device is undergoing charging.
